(19) United States
(12) Patent Application Publication
(10) Pub. No.: US 2011/0221933 A1
(43) Pub. Date: Sep. 15, 2011

(54) BACKLIGHT DETECTION DEVICE AND BACKLIGHT DETECTION METHOD

(76) Inventors: Xun Yuan, Beijing (CN); Zhongchao Shi, Beijing (CN); Cheng Zhong, Beijing (CN); Tong Liu, Beijing (CN); Gang Wang, Beijing (CN)

(21) Appl. No.: 12/986,456

(22) Filed: Jan. 7, 2011

(30) Foreign Application Priority Data
Mar. 9, 2010 (CN) 201010120389.5

(51) Int. Cl. H04N 9/68

(52) U.S. Cl. 348/234; 348/E09.053

(57) ABSTRACT

Disclosed are a backlight detection device and a backlight detection method. The device comprises a pixel value acquiring unit used to acquire a pixel value of each of pixels in an image; a focal position determination unit used to determine a focal position in the image; a subject area determination unit used to determine, based on the pixel values of the pixels in the image, a subject area starting from the focal position by using an area growth processing so as to divide the image into the subject area and a background area; a brightness difference calculation unit used to calculate a brightness difference between the subject area and the background area; and a backlight determination unit used to determine, based on the brightness difference, whether the image is in the backlight state so that the image in the backlight state can be detected.

### BACKGROUND OF THE INVENTION

1. Field of the Invention

The present invention relates to a backlight detection device and a backlight detection method used to determine whether an image is in a backlight state.

2. Description of the Related Art

In an exposure process where an imaging apparatus such as a digital camera, a radio-frequency video camera, etc., is utilized, in a case of photographing with backlight, a result is produced in general that a background portion is too bright and a really-interesting photographic subject, i.e., a target portion is too dark. Therefore backlight detection is widely employed in various functions of intelligent scene recognition, automatic exposure control, etc., of an imaging apparatus such as a digital camera, a video camera, etc.

A backlight detection technique is proposed in the below cited reference No. 1. In this backlight detection technique, the central and bottom portions of an image screen are determined as a main subject area, and the top portion of the image screen is determined as a background area. Then brightness difference between the main subject area and the background area is calculated. If the brightness difference is greater than a predetermined threshold value, it is determined that an image on the image screen is in a backlight state; otherwise it is determined that the image on the image screen is in a non-backlight state.

An automatic backlight detection technique used in a video camera is proposed in the below cited reference No. 2. In this automatic backlight detection technique, a predetermined template is adopted to determine a main subject area and a background area. If brightness difference between the main subject area and the background area is relatively high, it is determined that the corresponding image is in a backlight state.

Furthermore, a backlight detection method proposed in the below cited reference No. 3 is as follows: first a predetermined detection area is set on a portion of an image sensing plane; then light is detected based on difference in level of video signals corresponding to the inside and the outside of the predetermined detection area; finally, based on the detected result, it is determined that whether an image is in a backlight state.

And a backlight detection method proposed in the below cited reference No. 4 is as follows: first plural detection frames are set based on division of an imaging surface; then brightness level of each of the set detection frames is detected; next ratio between the brightness level detected from the detection frame having the lowest detected brightness level and the average value of the brightness levels detected from the detection frames other than the detection frame having the lowest brightness level is calculated; finally, if the ratio is greater than or equal to a predetermined value, it is determined that the corresponding image is in a backlight state. An existing problem in this method is that the area having the lowest brightness level is not always a subject area, i.e., there is a possibility of wrong determination with regard to the subject area; as a result, there may also be a possibility of wrong determination with regard to the backlight state on some level.

Furthermore a problem universally existing in the above-mentioned backlight detection techniques is that the division of the subject and background areas carried out according to the predetermined subject and background areas is fixed no matter in what circumstance the image is. As a result, if a real target is not located in the predetermined areas or the predetermined template, then the backlight detection cannot be achieved, or if the subject area is determined only by using brightness, then the wrong determination of the subject area may occur; at any rate, the performance of the backlight detection may be severely influenced.
Cited Reference No. 1: Masayuki Murakami and Nakaji Honda, An Exposure Control System of Video Cameras Based on Fuzzy Logic Using Color Information, Proceedings of the Fifth IEEE International Conference on Fuzzy Systems, 1996
Cited Reference No. 2: June-Sok Lee, You-Young Jung, Byung-Soo Kim, and Sung-Jea Ko, An Advanced Video Camera System with Robust AF, AE, and AWB Control, IEEE Transactions on Consumer Electronics, 2001
Cited Reference No. 3: U.S. Pat. No. 5,339,163
Cited Reference No. 4: U.S. Pat. No. 6,879,345
Cited Reference No. 5: US Patent Application Publication No. 2008/0232693
Cited Reference No. 6: Paul Viola and Michael J. Jones, Robust Real-Time Face Detection, International Journal of Computer Vision, 2004
Cited Reference No. 7: S Z Li, L Zhu, Z Q Zhang, A Blake, H J Zhang, and Harry Shum, Statistical Learning of Multi-view Face Detection, Proceedings of the 7^{th} European Conference on Computer Vision, 2002
Cited Reference No. 8: V. Vapnik, The Nature of Statistical Learning Theory, Springer-Verlag, New York, 1995

### SUMMARY OF THE INVENTION

The disadvantages of the prior art are overcome by the present invention. The present invention relates to image processing and pattern recognition, and provides a backlight detection device and a backlight detection method used to determine whether an image is in a backlight state. The backlight detection device and the backlight detection method in the embodiments of the present invention can be applied to an image apparatus such as a digital camera, a video camera, etc., without determining a subject area and a background area in advance; that is, in a case where there are not a fixed subject area and a fixed background area, the backlight state is automatically detected. Furthermore the embodiments of the present invention are not only dependent on brightness when determining the subject area and the background area. In the embodiments of the present invention, the subject area and the background area are automatically determined according to area growth started from a focal position; as a result, it is possible to determine the backlight state based on brightness difference between the subject area and the background area.

According to one aspect of the present invention, a backlight detection device used to determine whether an image is in a backlight state is provided. The backlight detection device comprises a pixel value acquiring unit used to acquire a pixel value of each of pixels in the image; a focal position determination unit used to determine a focal position in the image; a subject area determination unit used to determine, based on the pixel values of the pixels in the image, a subject area starting from the focal position by using area growth processing so as to divide the image into the subject area and a background area; a brightness difference calculation unit used to calculate brightness difference between the subject area and the background area; and a backlight determination unit used to determine, based on the brightness difference, whether the image is in the backlight state so as to detect the image in the backlight state.

According to another aspect of the present invention, a backlight detection method used to determine whether an image is in a backlight state is provided. The backlight detection method comprises a pixel value acquiring step of acquiring a pixel value of each of pixels in the image; a focal position determination step of determining a focal position in the image; a subject area determination step of determining, based on the pixel values of the pixels in the image, a subject area starting from the focal position by using area growth so as to divide the image into the subject area and a background area; a brightness difference calculation step of calculating brightness difference between the subject area and the background area; and a backlight determination step of determining, based on the brightness difference, whether the image is in the backlight state so as to detect the image in the backlight state.

Furthermore a predetermination process may also be carried out based on a brightness histogram before determining the focal position; in other words, an image that is apparently not in the backlight state may be directly discarded (i.e. follow-on processing is not applied to this kind of image) so as to increase detection speed.

The backlight detection device and the backlight detection method used to determine whether the image is in the backlight state according to the embodiments of the present invention can be applied to various imaging apparatuses for determining a backlight state; the determination processing may be carried out not only before an image is finally formed but also in a process of post-processing the finally formed image.

### BRIEF DESCRIPTION OF THE DRAWINGS

FIG. 1 is an overall block diagram of a backlight detection device according to an embodiment of the present invention.

FIG. 2 is a structural diagram of a focal position determination unit according to an embodiment of the present invention.

FIGS. 3A and 3B illustrate an example of dividing an image into a subject area and a background area by using a subject area determination unit according to an embodiment of the present invention; FIG. 3A illustrates the image, and FIG. 3B illustrate the division result of the image.

FIG. 4 is a functional diagram of a predetermination unit according to an embodiment of the present invention.

FIGS. 5A and 5B illustrate examples of brightness histograms of sample images in a backlight state.

FIGS. 6A and 6B illustrate examples of brightness histograms of sample images in a non-backlight state.

### DETAILED DESCRIPTION OF THE PREFERRED EMBODIMENTS

Hereinafter, the embodiments of the present invention will be concretely described with reference to the drawings.

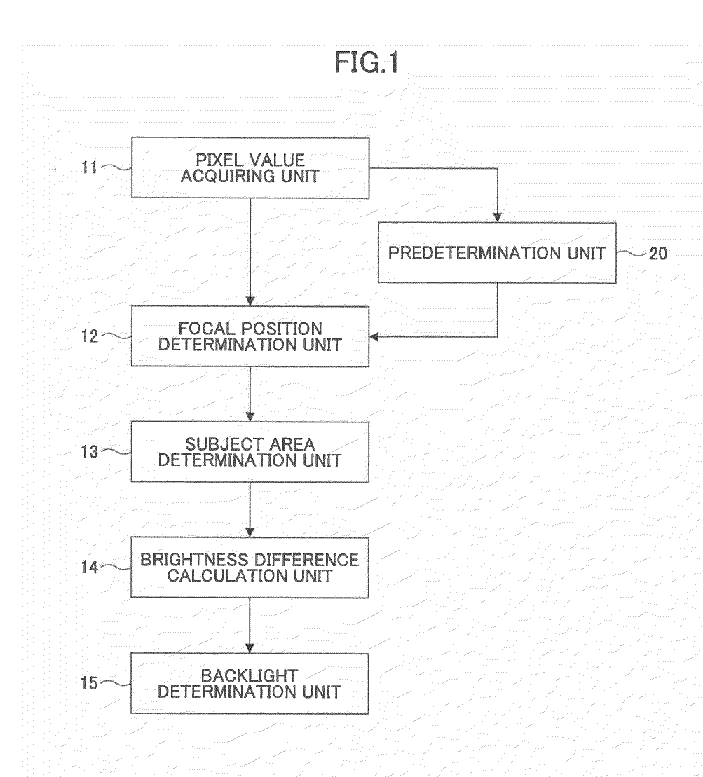

FIG. 1 is an overall block diagram of a backlight detection device according to an embodiment of the present invention. The backlight detection device according to the embodiment of the present invention is used to determine whether an image is in a backlight state. As shown in FIG. 1, the backlight detection device comprises a pixel value acquiring unit 11 used to acquire a pixel value of each of pixels in the image; a focal position determination unit 12 used to determine a focal position in the image; a subject area determination unit 13 used to determine a subject area based on the pixel value of each of the pixels in the image by using area growth started from the focal position so as to divide the image into the subject area and a background area; a brightness difference calculation unit 14 used to calculate bright difference between the subject area and the background area; and a backlight determination unit 15 used to determine whether the image is in the backlight state based on the brightness difference so as to detect the image in the backlight state. Furthermore a predetermination unit 20 may also be added to the backlight detection device for decreasing processing burden so that detection speed can be increased.

The backlight detection device according to the embodiment of the present invention may deal with a hierarchical color image formed by an imaging apparatus such as a digital camera, a video camera, etc. The pixel value acquiring unit 11 may acquire four channel values of each of pixels in the hierarchical color image. That is, a brightness channel value L, a red channel value R, a green channel value G, and a blue channel value B may be acquired; here R, G, and B stand for brightness values of red, green, and blue, respectively. Here it should be noted that all of the values of R, G, B and L may be automatically obtained by a conventional imaging apparatus based on a known technique in an image capturing process.

The pixel value acquiring unit 11 acquires signals of the pixel values of all of the pixels in the image; the signals are applied to a follow-on backlight detection process. Since the aim is to carry out backlight detection, it is possible to use a preview image whose resolution is lower than that of an image finally generated by an imaging apparatus; by this way, for example, it is possible to satisfy the demand of real-time processing in the imaging apparatus. The low-resolution preview image may be automatically and directly detected and obtained by an imaging apparatus such as a digital camera, a video camera, etc.; an actual example of the preview image is, for example, an image displayed on a liquid crystal display of an imaging apparatus such as a digital camera, a video camera, etc., before pressing down a shutter button, wherein, the resolution of the image is lower than that of a final image generated by the imaging apparatus after pressing down the shutter button in the same condition. Here it should be noted that it is apparent that the embodiments of the present invention may also be applied to the final image generated by the imaging apparatus.

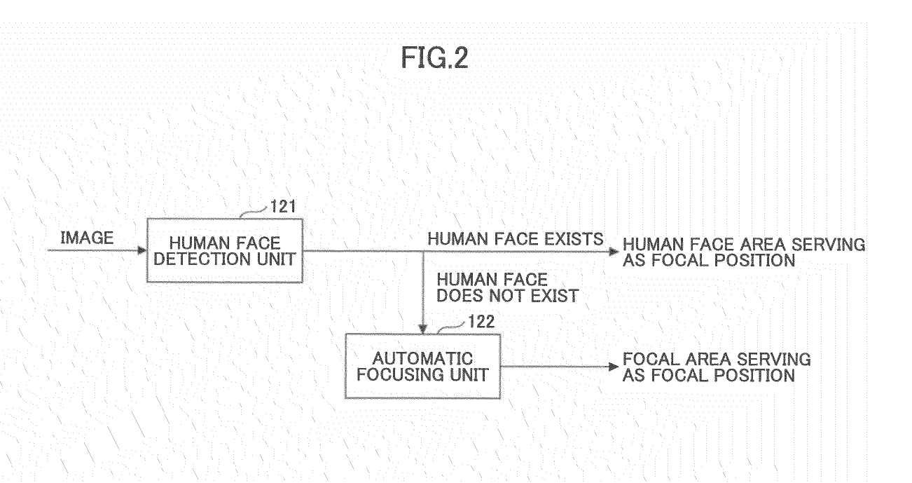

FIG. 2 is a structural diagram of the focal position determination unit 12 according to an embodiment of the present invention. As shown in FIG. 2, the focal position determination unit 12 comprises a human face detection unit 121 used to determine whether there is a human face in the image, wherein, if there is the human face in the image, then a human face area is detected and serves as a focal position; and an automatic focusing unit 122 used to carry out an automatic focusing processing so as to automatically obtain a focal area serving as the focal position if the human face detection unit 121 determines that there is not a human face in the image. The human face detection unit 121 may utilize a known human face detection technique to obtain the position and the size of the human face. In particular, it is possible to determine that an image, in which the number of the detected human faces is 0 (zero), is a human face nonexistence image; furthermore it is also possible to set a predetermined threshold value of size for determining whether an image is a human face nonexistence image, i.e., if all of the sizes of the detected human face areas are less than the predetermined threshold, then this image is determined as a human face nonexistence image.

The human face detection unit 121 may utilize various conventional human detection techniques, for example, a human face detection method disclosed in the cited reference No. 5 and human face detection techniques disclosed in the cited references No. 6 and No. 7, to carry out determination and detection of a human face.

If the human face detection unit 121 determines that there is not a human face in the image, then the human face detection unit 121 transmits the image to the automatic focusing unit 122. The automatic focusing unit 122 carries out automatic focusing processing with regard to the image so as to automatically obtain a focal area; this focal area serves as the focal position. Here it should be noted that the automatic focusing processing may be realized by a conventional imaging apparatus based on a known technique.

The subject area determination unit 13 may determine a subject area in the image by employing a known algorithm of area growth. For example, the subject area determination unit 13 may first create a m×n matrix M (here m and n are counting numbers) whose size is equal to the size of the image being processed; in other words, the respective elements in the matrix M correspond to the respective pixels in the image being processed. And the initial value of each of the elements in the matrix M is set to 0. Then a m×n matrix b whose size is equal to the size of the matrix M is created. Since the size of the matrix b is equal to the size of the matrix M, the elements in the matrix b correspond to the pixels in the image being processed. According to the result (i.e. the focal position) obtained by the focal position determination unit 12, with regard to all the elements in the matrix b, the initial values of the elements corresponding to the pixels located at the focal position in the image are set to 1, and the initial values of the other elements are set to 0.

Next an area growth process is carried out. It is supposed that b(x,y) stands for the respective elements in the matrix b, and M(x,y) stands for the respective elements in the matrix M; here x and y stand for a row position and a column position of each of the elements in the corresponding matrix, respectively, and both x and y are counting numbers. Then the respective elements b(x,y) in the matrix b are checked in series. If the value of one of b(x,y) is 1 and the value of the corresponding M(x,y) is 0, then the value of the corresponding M(x,y) is set to 1, and (x,y) is determined as a start point from which the area growth process growing to the neighboring points begins to be carried out. If it is supposed that a start point is (x₀,y₀), then only when the following equation (1) is satisfied, it is determined that the start point merges with its neighboring points (xᵢ, yᵢ); here i refers to an index, and is a counting number between 1 and 8.

abs(G(xᵢ,yᵢ)−G(x₀,y₀))+abs(R(xᵢ,yᵢ)−R(x₀,y₀))+abs(B(xᵢ,yᵢ)−B(x₀,y₀))<d (1)

Here d is a predetermined threshold value; abs( ) refers to the calculation of absolute value; R( ), G( ), and B( ) refer to R, G, and B channel values, respectively. When the area growth process started from the start point stops, a pixel, which is close to the start point and has the similar color expression, in the matrix M is set to 1. After all the elements in the matrix b are checked, the subject area determination unit 13 outputs the matrix M as the result of the subject area determination processing. The pixels, which correspond to the elements whose values in matrix M are 1, form the subject area, and the pixels, which correspond to the elements whose values in matrix M are 0, form the background area.

The above-mentioned process may be expressed by the following STEPS.

STEP 1: creating a m×n matrix M in which element values are initialized to 0, i.e. M(i,j)=0;

STEP 2: creating a stack S whose contents are initialized to “empty” values;

STEP 3: x=0, y=0, and setting a predetermined threshold value d;

STEP 4: if (M(x,y)==0 and b(x,y)==1), then
STEP 4.1: M(x,y)=1;
STEP 4.2: S.push(x,y);
STEP 4.3: if S is empty, then going to STEP 5; otherwise (x₀,y₀)=S.pop( );
STEP 4.4: as for the corresponding pixel b(x₀,y₀) of M(x₀,y₀), considering its 8 neighboring pixels b(xᵢ,yᵢ) (here i=1, . . . , 8);
   STEP 4.4.1: Diff=abs(G(xᵢ,yᵢ)−G(x₀,y₀))+abs(R(xᵢ,yᵢ)−R(x₀,y₀))+abs(B(xᵢ,yᵢ)−B(x₀,y₀));
   STEP 4.4.2: if (Diff<d and M(xᵢ,yᵢ)==0), then M(xᵢ,yᵢ)=1, and then S.push(xᵢ,yᵢ);
STEP 4.5: going to STEP 4.3;

STEP 5: x=x+1;

STEP 6: if (x≧m), then x=0 and y=y+1;

STEP 7: if (y≧n), then exiting; otherwise going to STEP 4.

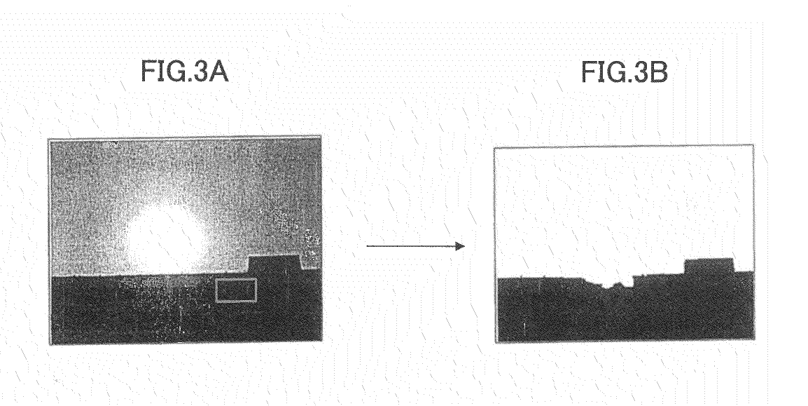

FIGS. 3A and 3B illustrate an example of dividing an image into a subject area and a background area by using a subject area determination unit according to an embodiment of the present invention; FIG. 3A illustrates the image, and FIG. 3B illustrate the division result of the image. In FIG. 3A, the framed rectangle portion is a focal position; in FIG. 3B, the white portion is the background area, and the black portion is the subject area.

The brightness difference calculation unit 14 calculates brightness difference between the subject area and the background area. If the brightness difference between the subject area and the background area is greater than or equal to a predetermined threshold value, then the backlight determination unit 15 determines that this image is in a backlight state, or in other words, this image is a backlight image; otherwise the backlight determination unit 15 determines that this image is in a non-backlight state, or in other words, this image is a non-backlight image.

As a further improvement of the embodiments of the present invention, as shown in FIG. 1; that is, before the focal position determination unit 12 determines the focal position, it may be possible to use a predetermination unit 20 for discarding one or more images which are apparently not in a backlight state so that the detection speed can be increased.

For example, the predetermination 20 may utilize the pixel value acquiring unit 11 to acquire brightness channel values in the pixel values of all of the pixels in the image, and then predetermine, based on a brightness histogram of this image, that this image is a candidate backlight image or a non-backlight image. In a case where this image is predetermined as the candidate backlight image, this image is output to the focal position determination unit 12 for carrying out the follow-on processing. In a case where this image is predetermined as the non-backlight image, the processing applied to this image stops. The predetermined unit 20 may obtain a classification function by carrying out training based on plural known sample images which are in a backlight state and plural known sample images which are in a non-backlight state.

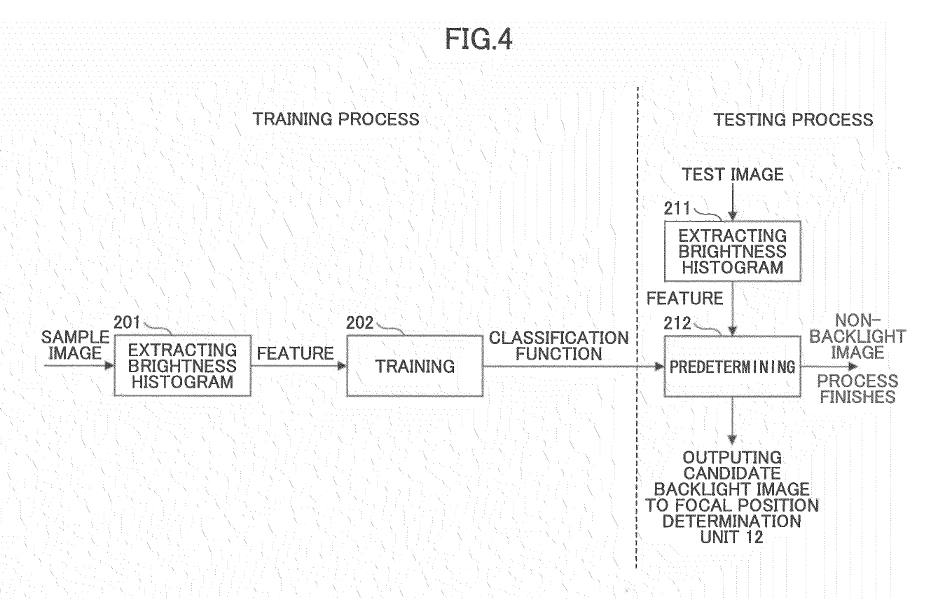

FIG. 4 is a functional diagram of a predetermination unit according to an embodiment of the present invention; in FIG. 4, the left side of a dotted line illustrates a training process using sample images, and the right side of the dotted line illustrates a testing process applied to a test image prepared to be processed. In the training process, the predetermination unit 20 extracts brightness histograms of the respective sample images based on brightness channel values of the respective sample images in STEP 201; for example, the available range of brightness channel values may be from 0 to 1020, and is quantized to 16 brightness levels. The initial value of the number of the pixels corresponding to 16 brightness levels in the respective brightness histograms is set to 0. As for each of the pixels in each of the sample images, in a case where its brightness channel value is at one of 16 brightness levels, 1 is added to the number of the pixels corresponding to this level. After this kind of operation is applied to all the pixels in each of the sample images, the brightness histogram finally extracted by the predetermination unit 20 with regard to all the pixels in the corresponding sample image can be obtained; the brightness histogram may be used as a feature of the corresponding sample image.

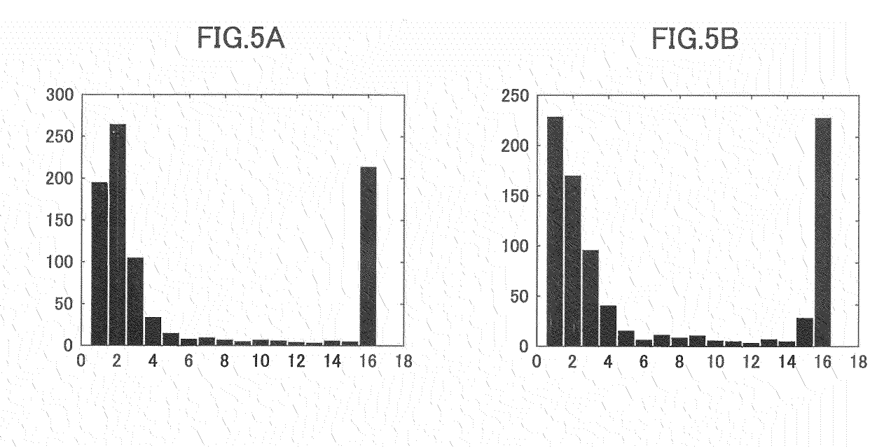

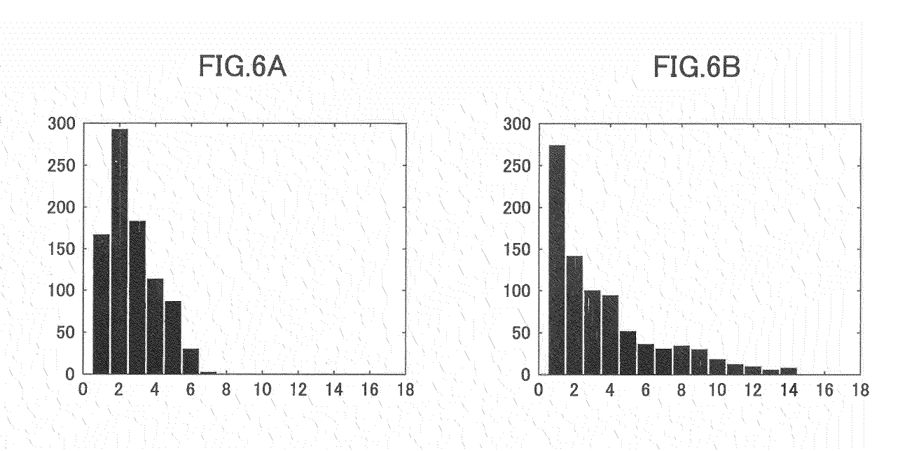

FIGS. 5A and 5B illustrate examples of brightness histograms of sample images in a backlight state. FIGS. 6A and 6B illustrate examples of brightness histograms of sample images in a non-backlight state. In each of the brightness histograms, the abscissa axis stands for brightness level, and the vertical axis stands for the number of pixels corresponding to the brightness levels in the respective sample images; here it should be noted that the respective brightness histograms are only examples for purpose of illustration. According to FIGS. 5A and 5B, it is apparent that in a case where the sample images are in a backlight state, their brightness histograms have peak values at two ends of the brightness levels in general. And according to FIGS. 6A and 6B, it is apparent that in a case where the sample images are in a non-backlight state, their brightness histograms do not have the above-mentioned property of the brightness histograms of the sample images in a backlight state. As a result, in STEP 202, a classifier may learn the differences between the brightness histograms of the backlight images and the brightness histograms of the non-backlight images so that a classification function used for carrying out classification determination can be created. The purpose of training the classifier so as to create the classification function is to discard most cases where sample images apparently are non-backlight ones so as to reserve backlight sample images for carrying out the follow-on processing. In this embodiment, it is possible to adopt a known support vector machine (SVM) with a linear kernel to create the classification function. Here it should be noted that SVM is a known algorithm, and is disclosed in the cited reference No. 8.

In the testing process, the predetermination unit 20 deals with a test image prepared to be processed. In STEP 211, a brightness histogram of the test image is extracted and serves as the feature of this test image. In STEP 212, the obtained classification function is utilized to calculate the feature (i.e. the brightness histogram) of the test image so as to predetermine whether the test image is a non-backlight image. Here it should be noted that since this determination processing is predetermination processing, if the test image is predetermined as a backlight image, then it may be called a candidate image. If the test image is predetermined as a non-backlight image, then the processing applied to the test image stops; if the test image is predetermined an a backlight image, then the test image is transmitted to the focal position determination unit 12 for carrying out the follow-on processing.

In particular, according to the SVM method, in the training process, plural flagged backlight sample images and non-backlight sample images serve as positive samples and negative samples, respectively. With regard to each of the samples, a feature vector fᵢ is extracted; here i is an index of the samples, and is a counting number. The feature vector is, for example, a brightness histogram. If it is supposed that p positive samples and q negative samples are adopted, then the total number k=p+q; here p, q, and k are counting numbers. As a result, a feature vector set F={fᵢ} (i=1, . . . k) can be obtained, and a flag set Y={yᵢ} (i=1, . . . k) can be obtained too; here yᵢ is a class flag corresponding to the feature vector fᵢ, and can be defined as follows.

$${y}_{i} = \{ \begin{matrix}1 & if {f}_{i} refers to a positive sample \\ 0 & if {f}_{i} refers to a negative sample\end{matrix} \qquad ( 2 )$$

Before STEP 202 is carried out, first a kernel function K is selected; in this embodiment, it is possible to select a linear kernel function defined as follows.

K(g,h)=g·h (3)

That is, the kernel function K calculates the inner product of the two vectors g and h as shown in the above equation (3).

In the training process, according to the SVM training algorithm, nv vectors are selected from the feature vector set F to form a support vector set V={vᵢ} for determining the classification function; here i is an index, and i=1, . . . , nv. And according to this training algorithm, a weight aᵢ is given to the respective vectors vᵢ

In the testing process, in STEP 212, with regard to a feature vector v (i.e. the brightness histogram extracted in STEP 211) of the test image prepared to be processed, it may be determined by adopting a classification function fun( ) defined by the following equation (4).

fun(v)=Σ_{y=1}^{nv}yᵢ*aᵢ*K(vᵢ,v)+b (4)

Here yᵢ is a class flag corresponding to the vector vᵢ and b is a constant calculated by the SVM training algorithm.

In a case where the linear kernel function is adopted, equation (5) may be obtained based on the above-mentioned classification function as follows.

$$\begin{matrix}fun ( v ) = {\sum }_{i = 1}^{nv} {y}_{i} * {a}_{i} * K ( {v}_{i} , v ) + b \\ = {\sum }_{i = 1}^{nv} {y}_{i} * {a}_{i} * ( {v}_{i} \cdot v ) + b \\ = {\sum }_{i = 1}^{nv} ( ( {y}_{i} * {a}_{i} * {v}_{i} ) \cdot v ) + b \\ = ( {\sum }_{i = 1}^{nv} {y}_{i} * {a}_{i} * {v}_{i} ) \cdot v + b \\ = w \cdot v + b\end{matrix} \qquad ( 5 )$$

Since all of yᵢ, aᵢ, vᵢ, and nv are known amounts in the training process, (Σᵢ₌₁^{nv}yᵢ*aᵢ*vᵢ) may be expressed as w. And since w may be calculated in advance, determination time in the testing process cannot be influenced.

As for the feature vector v of the test image prepared to be processed, its class flag yᵥ may be defined as follows.

$${y}_{v} = \{ \begin{matrix}1 & fun ( v ) \geq 0 \\ 0 & fun ( v ) < 0\end{matrix} \qquad ( 6 )$$

If the calculation result of the classification function fun( ) with regard to the feature vector v is greater than or equal to 0, then the class flag yᵥ of the feature vector v is set to 1 that means that the test image corresponding to the feature vector v may be classified as a positive sample, i.e., in this embodiment, means that the test image is predetermined as a candidate backlight image and the follow-on determination processing will be carried out. If the calculation result of the classification function fun( ) with regard to the feature vector v is less than 0, then the class flag yᵥ of the feature vector v is set to 0 that means that the test image corresponding to the feature vector v may be classified as a negative image, i.e., in this embodiment, means that the test image is predetermined as a non-backlight image and its processing stops (i.e. the follow-on determination processing will not be carried out).

Here it should be noted that the above-mentioned support vector machine (SVM) method is just used as an example to explain how to carry out the training and how to carry out the predetermination with regard to the test image prepared to be processed; in other words, those practiced in the art can understand that it is also possible to adopt other known machine learning methods, for example, k-NN, AdaBoost, etc., to train the classifier and to carry out the predetermination of whether the test image is a backlight image.

Furthermore a backlight detection method used to determine whether an image is in a backlight state is provided. The backlight detection method comprises a pixel value acquiring step, which may be executed by the pixel value acquiring unit 11, of acquiring a pixel value of each of the pixels in the image; a focal position determination step, which may be executed by the focal position determination unit 12, of determining a focal position in the image; a subject area determination step, which may be executed by the subject area determination unit 13, of determining, based on the pixel values of the pixels in the image, a subject area starting from the focal position by using area growth processing so as to divide the image into the subject area and a background area; a brightness difference calculation step, which may be executed by the brightness difference calculation unit 14, of calculating brightness difference between the subject area and the background area; and a backlight determination step, which may be executed by the backlight determination unit 15, of determining, based on the brightness difference, whether the image is in the backlight state so as to detect the image in the backlight state.

The image may be a hierarchical color image, and the pixel value may include a brightness channel value, a red channel value, a green channel value, and a blue channel value of the corresponding pixel. Furthermore the image may be a preview image whose resolution is lower than that of an image finally generated by an imaging apparatus; in particular, an actual example of the preview image is, for example, an image displayed on a liquid crystal display of an imaging apparatus such as a digital camera, a video camera, etc. before pressing down a shutter button.

The focal position determination step comprises a human face detection step, which may be executed by the human face detection unit 121, of determining whether there is a human face in the image, wherein, if there is the human face in the image, then a human face area is detected and serves as the focal position; and an automatic focusing step, which may be executed by the automatic focusing unit 122, of carrying out automatic focusing processing so as to automatically obtain a focal area serving as the focal position if the human face detection step determines that there is not a human face in the image.

If the brightness difference between the subject area and the background area is greater than a predetermined value, then the backlight determination step determines that the image is in the backlight state.

The backlight detection method according to the embodiment of the present invention may further comprise a predetermination step, which may be executed by the predetermination unit 20, of predetermining the image as a candidate backlight image or a non-backlight image based on the above-mentioned brightness histogram of the image, wherein, in a case where the image is predetermined as the candidate backlight image, the image is output to the focal position determination step, and in a case where the image is predetermined as the non-backlight image, processing with regard to the image stops.

Furthermore, in the predetermination step, a classification function is obtained by carrying out training according to plural known sample images which are in a backlight state and plural known sample images which are in a non-backlight state.

A series of operations described in this specification can be executed by hardware, software, or a combination of hardware and software. When the operations are executed by software, a computer program can be installed in a dedicated built-in storage device of a computer so that the computer can execute the computer program. Alternatively, the computer program can be installed in a common computer by which various types of processes can be executed so that the common computer can execute the computer program.

For example, the computer program may be stored in a recording medium such as a hard disk or a ROM in advance. Alternatively, the computer program may be temporarily or permanently stored (or recorded) in a movable recording medium such as a floppy disk, a CD-ROM, a MO disk, a DVD, a magic disk, or a semiconductor storage device. And also it is possible to let these kinds of movable recording media be packaged software for purpose of distribution.

While the present invention is described with reference to the specific embodiments chosen for purpose of illustration, it should be apparent that the present invention is not limited to these embodiments, but numerous modifications could be made thereto by those skilled in the art without departing from the basic concept and scope of the present invention.

The present application is based on Chinese Priority Patent Application No. 201010120389.5 filed on Mar. 9, 2010, the entire contents of which are hereby incorporated by reference.

What is claimed is:

1. A backlight detection device used to determine whether an image is in a backlight state, comprising:
a pixel value acquiring unit used to acquire a pixel value of each of pixels in the image;
a focal position determination unit used to determine a focal position in the image;
a subject area determination unit used to determine, based on the pixel values of the pixels in the image, a subject area starting from the focal position by using an area growth processing so as to divide the image into the subject area and a background area;
a brightness difference calculation unit used to calculate a brightness difference between the subject area and the background area; and
a backlight determination unit used to determine, based on the brightness difference, whether the image is in the backlight state so that the image in the backlight state can be detected.

2. The backlight detection device according to claim 1, wherein:
the image is a hierarchical color image, and the pixel value include a brightness channel value, a red channel value, a green channel value, and a blue channel value of the corresponding pixel.

3. The backlight detection device according to claim 1, wherein:
the image is one whose resolution is lower than that of an image finally generated by an imaging apparatus.

4. The backlight detection device according to claim 1, wherein, the focal position determination unit comprises:
a human face detection unit used to determine whether there is a human face in the image, wherein, if there is a human face in the image, then a human face area is detected and serves as the focal position; and
an automatic focusing unit used to carry out an automatic focusing processing so as to automatically obtain a focal area serving as the focal position if the human face detection unit determines that there is not a human face in the image.

5. The backlight detection device according to claim 1, wherein:
if the brightness difference between the subject area and the background area is greater than a predetermined value, then the backlight determination unit determines that the image is in the backlight state.

6. The backlight detection device according to claim 1, further comprising:
a predetermination unit used to predetermine the image as a candidate backlight image or a non-backlight image based on a brightness histogram of the image, wherein, in a case where the image is predetermined as the candidate backlight image, the image is output to the focal position determination unit, and in a case where the image is predetermined as the non-backlight image, a processing being applied to the image stops.

7. The backlight detection device according to claim 6, wherein:
the predetermination unit obtains a classification function by carrying out a training according to plural known sample images which are in the backlight state and plural known sample images which are in a non-backlight state.

8. A backlight detection method used to determine whether an image is in a backlight state, comprising:
a pixel value acquiring step of acquiring a pixel value of each of pixels in the image;
a focal position determination step of determining a focal position in the image;
a subject area determination step of determining, based on the pixel values of the pixels in the image, a subject area starting from the focal position by using an area growth processing so as to divide the image into the subject area and a background area;
a brightness difference calculation step of calculating a brightness difference between the subject area and the background area; and
a backlight determination step of determining, based on the brightness difference, whether the image is in the backlight state so that the image in the backlight state can be detected.

9. The backlight detection method according to claim 8, wherein, the focal position determination step comprises:
a human face detection step of determining whether there is a human face in the image, wherein, if there is a human face in the image, then a human face area is detected and serves as the focal position; and
an automatic focusing step of carrying out an automatic focusing processing so as to automatically obtain a focal area serving as the focal position if the human face detection step determines that there is not a human face in the image.

10. The backlight detection method according to claim 8, further comprising:
a predetermination step of predetermining the image as a candidate backlight image or a non-backlight image based on a brightness histogram of the image, wherein, in a case where the image is predetermined as the candidate backlight image, the image is output to the focal position determination step, and in a case where the image is predetermined as the non-backlight image, a processing being applied to the image stops.
